(19) United States
(12) Patent Application Publication
(10) Pub. No.: US 2018/0197432 A1
(43) Pub. Date: Jul. 12, 2018

(54) CLASS ASSESSMENT TOOL WITH A FEEDBACK MECHANISM

(71) Applicant: WSE Hong Kong Limited, Hong Kong (CN)

(72) Inventors: Kenneth Robert DAVIS, Barcelona (ES); Ian WOOD, Cambridge (GB); Mollie Christina WOLCOTT, Bethesda, MD (US)

(21) Appl. No.: 15/837,982

(22) Filed: Dec. 11, 2017

Related U.S. Application Data
(60) Provisional application No. 62/444,187, filed on Jan. 9, 2017.

(51) Int. Cl. G09B 7/02; G06F 17/30; G09B 5/00

(52) U.S. Cl. CPC G09B 7/02; G06F 17/30876; G09B 19/06; G09B 5/00; G06F 17/30312

(57) ABSTRACT

A wireless client device having a touchscreen may run a class assessment tool. The tool may have an interface that displays a row of student pictures and names and enables a teacher to assess the students on various key aspects. The tool may display a rubric for each key aspect when the key aspect is hovered over or selected. The interface may include a matrix of assessment blocks having a plurality of individually selectable areas that enable a teacher to enter a key aspect score for each key aspect for each student. The interface may include a row of comment areas configured to receive a private message for a student and a row of final scores based on the key aspect scores of the student. A row of results may be displayed, where each result reflects whether a student passed or failed the class based on the student's final score.

### CROSS REFERENCE TO RELATED APPLICATIONS

This application claims priority to U.S. Provisional Patent Application No. 62/444,187, filed on Jan. 9, 2017, and entitled “Class Assessment Tool With a Feedback Mechanism.”

### FIELD OF THE INVENTION

The present invention relates to a wireless electronic client device comprising a touch screen display that assists a person in evaluating participants in a program.

### SUMMARY OF THE INVENTION

A client device having a touch screen display may be used by a person evaluating participants in a program to quickly and easily assess the participants' abilities on a number of different key aspects taught in the class. As a specific example, the person doing the evaluation may be a teacher and the participants may be students in a class. As an even more specific example, the teacher may be teaching a language, such as English, to the students.

The client device may display an interface of a class assessment tool. The display or the interface may have a row of student pictures and names. In preferred embodiments, student pictures and names may be added, deleted and rearranged as desired by the teacher using the touch screen of the client device. The client device may retrieve the pictures and names from a database and/or the client device may be used to take the pictures and allow the teacher to enter the names of the students. Each picture and name of a student may be used to define a column on the display or interface.

The display or interface may have a column of key aspects taught in the class below and preferably to the left of the row of student names. The key aspects may be read by the client device from a database or the key aspects for a plurality of different classes may be preprogrammed into the client device. Pressing or hovering over a key aspect in the column of key aspects may trigger or cause a rubric for that specific key aspect to be displayed on the display or interface. The rubric promotes uniform grading by all the teachers in all the different class locations by providing a uniform metric upon which to assess or evaluate the students.

A matrix of assessment blocks may be displayed under the row of students and to the right of the column of key aspects so that each student in the row of students has an assessment block for each key aspect in the column of key aspects. In preferred embodiments, each assessment block comprises a plurality, such as four, of individually selectable assessment areas. A teacher may thus select one of the assessment areas, based on a key aspect score the teacher selects for the student, in an assessment block to give a student a score for a key aspect taught in the class. In a preferred embodiment, each assessment block comprises four individually selectable assessment areas which gives a student a key aspect score of 1, 2, 3 or 4. The individually selectable assessment areas may be highlight or colored so that the teacher may easily see the key aspect score each student received for each key aspect in the column of key aspects.

A row of final scores may be displayed on the display of the client device or the interface of the class assessment tool below the matrix of assessment blocks. Each final score in the row of final scores may provide an indication of how the student did for all of the key aspects in the column of key aspects. The final score may be given on any scale, but is preferably a percentage based on the key aspect scores the student received.

A row of comment areas may be displayed on the display of the client device or the interface of the class assessment tool below the row of students and preferably below the row of final scores. The teacher may select a comment area to enter a comment that may be communicated to a student. In a preferred embodiment, when the teacher selects a comment area, a larger comment bubble appears and enables the teacher to easily enter a comment to the student.

A row of results may be displayed on the display of the client device or the interface of the class assessment tool below the row of students and preferably below the row of comment areas. Each result in the row of results may be automatically determined based on the final score received by a student or the teacher may select an icon in the row of results that causes a drop-down menu to appear that allows the teacher to select a result for the student. The result is preferably either fail (in which case the student should retake the class) or pass (in which case the student should take the next class in a series of classes).

After the teacher has entered the key aspect scores and results for the students in the class, the teacher may select an option to finish the class and save the results. Once the teacher selects the option to finish the class and save the results, the client device may transmit the key aspect scores, final scores and/or results for each student to a database. In preferred embodiments, the database is accessible to an administrator of the database, student scores for students are accessible to a teacher of the students and student scores are accessible by the student receiving the scores.

The above features and advantages of the present invention will be better understood from the following detailed description taken in conjunction with the accompanying drawings.

### BRIEF DESCRIPTION OF THE DRAWINGS

FIG. 1 is a block diagram of a system that may be used to practice the invention. The system comprises a client device to assist a teacher in assessing students and then stores the results in a database that may be accessed by other teachers using other client devices anywhere in the world.

FIGS. 2 and 3 are flowcharts illustrating an embodiment of the invention for a teacher using a class assessment tool running on a wireless client device having a touch screen display to assess one or more students in a class.

FIGS. 4-8 are flowcharts illustrating another embodiment of the invention for a teacher using a class assessment tool running on a wireless client device having a touch screen display to assess one or more students in a class.

FIG. 9 is a partial screenshot of an interface for a class assessment tool displayed on a touch screen of a wireless client device illustrating a row of student, a column of key aspects for a class and a matrix of assessment blocks.

FIG. 10 is a partial screenshot of an interface for a class assessment tool displayed on a touch screen of a wireless client device illustrating a column of key aspects for a class, a matrix of assessment blocks and a row of final scores.

FIG. 11 is a partial screenshot of an interface for a class assessment tool displayed on a touch screen of a wireless client device illustrating a column of key aspects for a class, a matrix of assessment blocks, a row of final scores and a pop-up rubric displayed over the matrix of assessment blocks.

FIG. 12 is a partial screenshot of an interface for a class assessment tool displayed on a touch screen of a wireless client device illustrating a row of final scores, a row of comment areas and a row of results.

FIG. 13 is a partial screenshot of an interface for a class assessment tool displayed on a touch screen of a wireless client device illustrating a row of final scores, a row of comment areas and a comment bubble.

FIG. 14 is a partial screenshot of an interface for a class assessment tool displayed on a touch screen of a wireless client device illustrating a row students and a feedback icon.

FIG. 15 is a partial screenshot of an interface for a class assessment tool displayed on a touch screen of a wireless client device illustrating a save results option.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

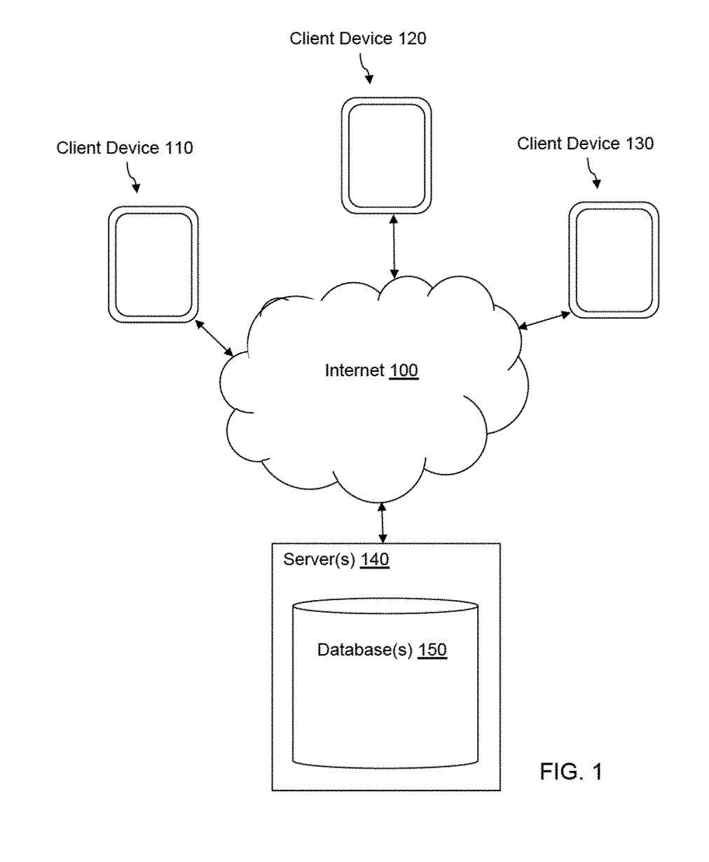

Referring to FIG. 1, an embodiment of the invention includes a plurality of client devices 110, 120, 130 that are connected to the Internet 100. The client devices 110, 120, 130 comprise a display capable of displaying an interface for a class assessment tool more fully described below. Each client device 110 may have a touch screen to enable a teacher to easily interact with the client device 110. In preferred embodiments, the client devices 110, 120, 130 further comprise a camera for taking pictures and video recordings, a microphone for recording audio clips and/or a speaker for playing audio clips. The client devices 110, 120, 130 are preferably light weight and easy to move around a class room. While the client devices 110, 120, 130 may be a desk top computer, laptop computer and/or smart phone, the client devices 110, 120, 130 are preferably wireless handheld electronic devices, such as a tablet. As non-limiting examples, the client devices 110, 120, 130 may be an Apple iPad™, a Samsung Galaxy Tablet™ and/or an AT&T Trek HD™ Tablet.

The plurality of client devices 110, 120, 130 communicate over the Internet 100 with one or more servers 140 comprising one or more databases 150. The one or more servers 140 may be any desired type of server that can receive and transmit data over the Internet 100 and can store data in one or more databases 150. As non-limiting examples, the servers 140 may be one or more Dell PowerEdge™ servers, Intel Server System™ servers and/or IBM eServer xSeries™ servers.

The database 150 must be able to receive, via the Internet 100 and servers 140, and store student information and historical data from each of the client devices 110, 120, 130. The database 150 must also be able to read student information and historical data and transmit, via the servers 140 and Internet 100, the student information and historical data to each of the client devices 110, 120, 130. The database 150 may be any type of database that can be updated and that can store data for extending period of times (such as years). As non-limiting examples, the database 150 may be on a hard disk drive, a solid-state drive or a tape drive and may be a central or distributed database.

A client device 110, 120, 130 having a touch screen display may be used by a person evaluating participants in a program to quickly and easily assess the participants' abilities on a number of different key aspects taught in the class. As a specific example, the person doing the evaluation may be a teacher and the participants may be students in a class.

As a non-limiting example, the teacher may teach an English lesson to a class of students learning English. The English lesson may include the topics of language related to living arrangements, language related to someone's appearance, language related to someone's personality, language related to making a basic introduction and language showing preferences—such as would plus like, love or hate. At the end of the lesson, the teacher may desire to assess each student to determine whether each student passed the lesson and thus should proceed to the next lesson or failed the lesson and thus should repeat the lesson.

The various embodiments of the invention make it easier for the teacher to evaluate and assess each student in an objective manner so that each student is evaluated fairly and consistently (even between different teachers) and the teacher has confidence in the teacher's assessment of each student.

Current methods of evaluating students often do not require the teacher to evaluate all students on the same topics/skills (key aspects) nor do the always require the teacher to use the same objective standards in assessing each student. The present invention provides a plurality of custom key aspects for every class that all students, regardless of the teacher or teaching location, are assessed on. In addition, the present invention provides an objective standard in assessing each key aspect, where the objective standard is easily accessible to the teacher while grading each student on a mobile client device. Specifically, a rubric specific for each key aspect may be displayed next to the rubric's associated key aspect on the client device to ensure that an objective standard is being used in assessing each student on each key aspect taught in the class.

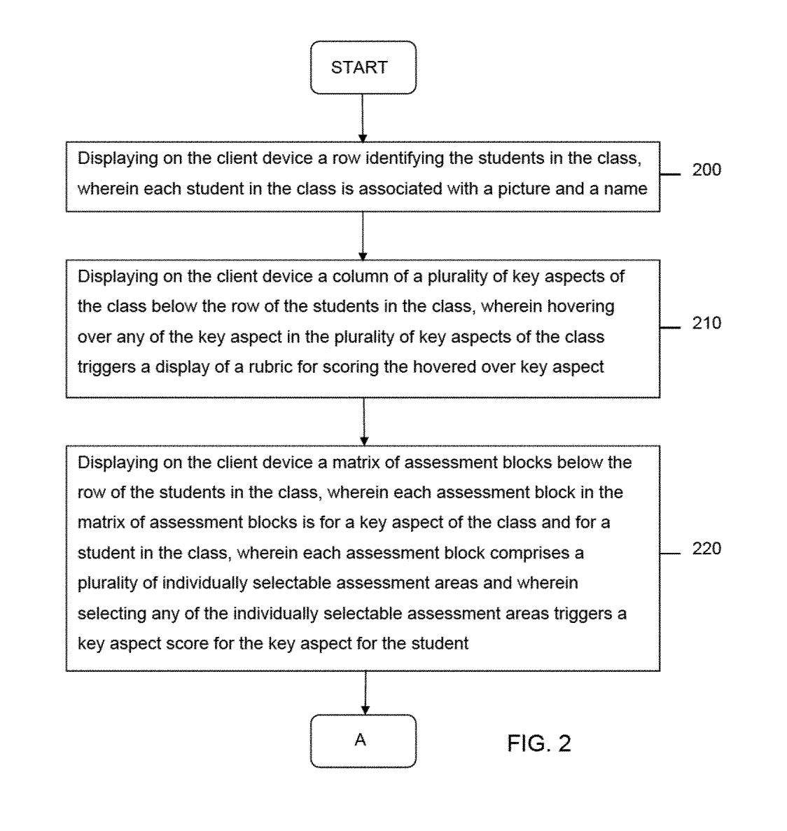

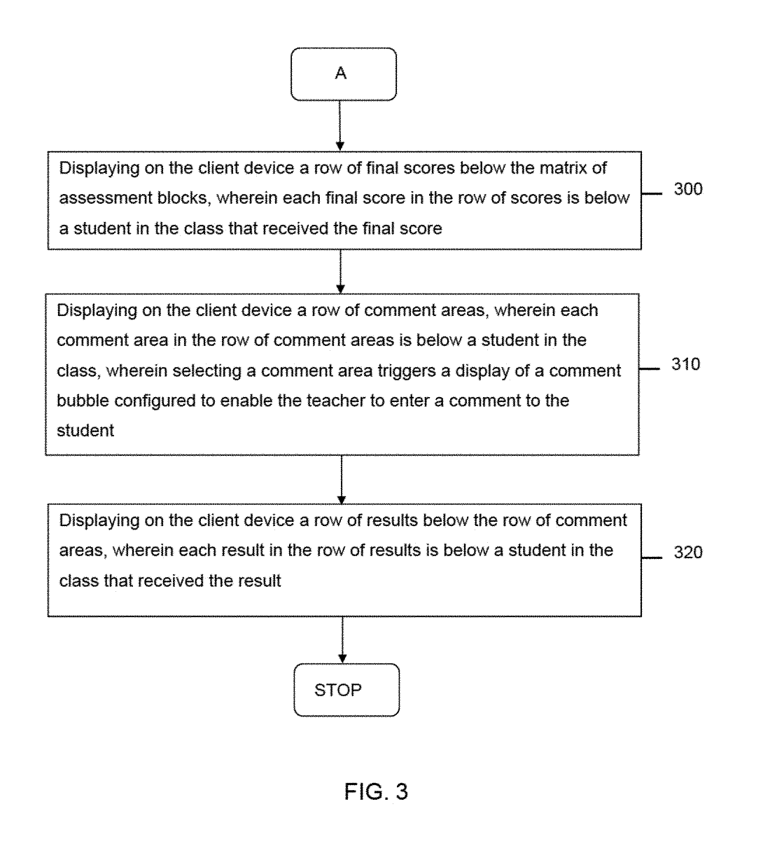

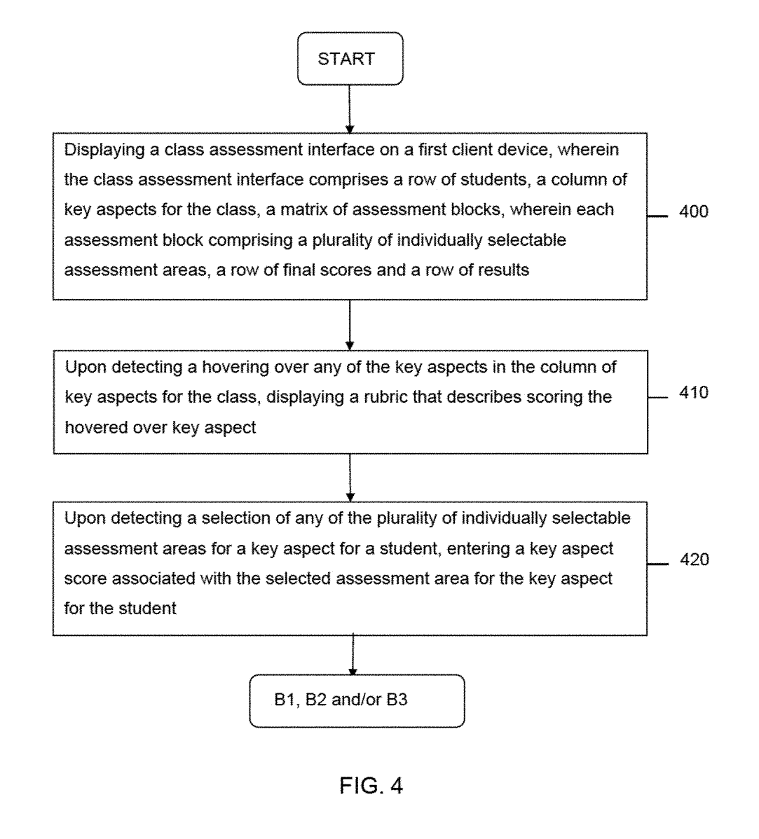

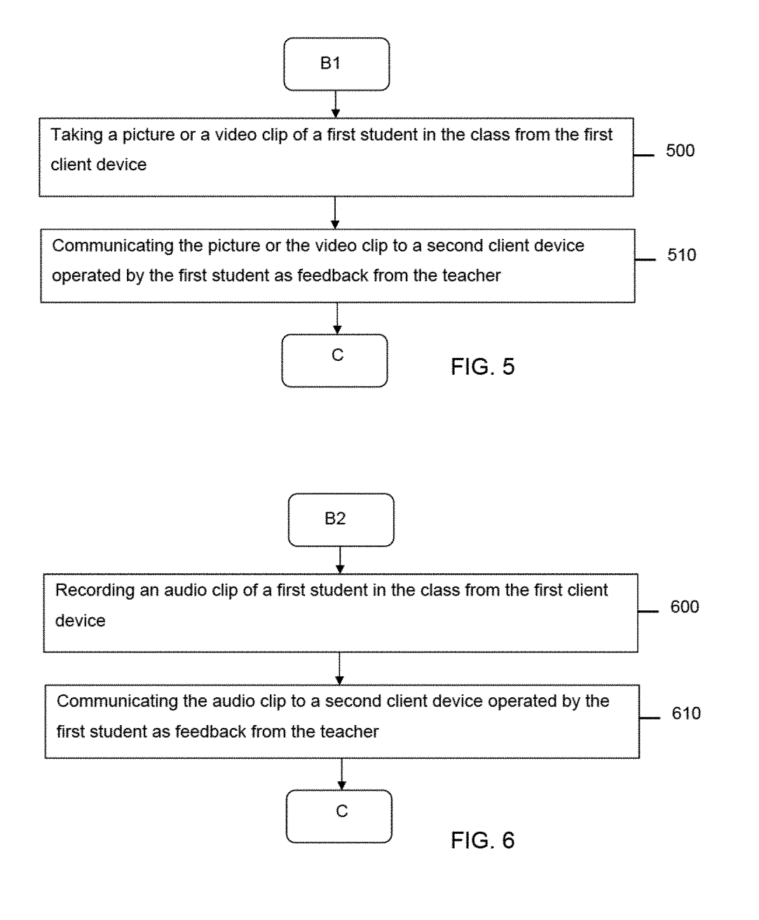

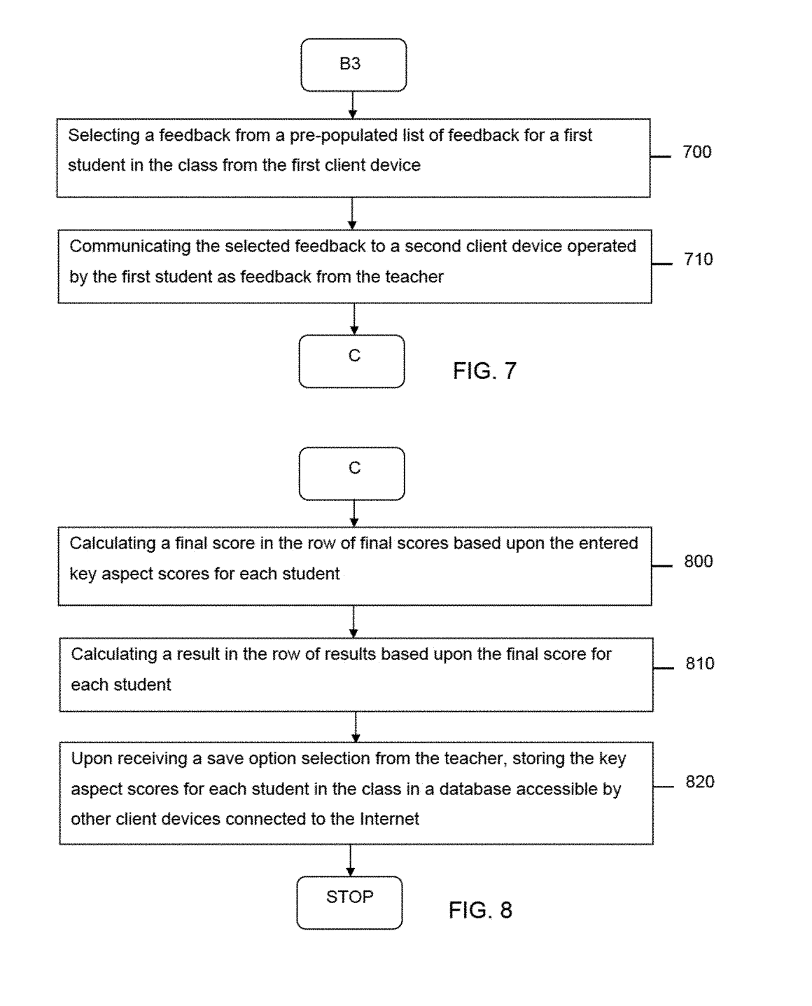

Referring to FIGS. 2-9, an example method of assessing one or more students in a class is provided. The teacher may use a wireless client device 110 comprising a touch screen display. An interface for a class assessment tool running on the client device may be displayed on the display of the client device 110.

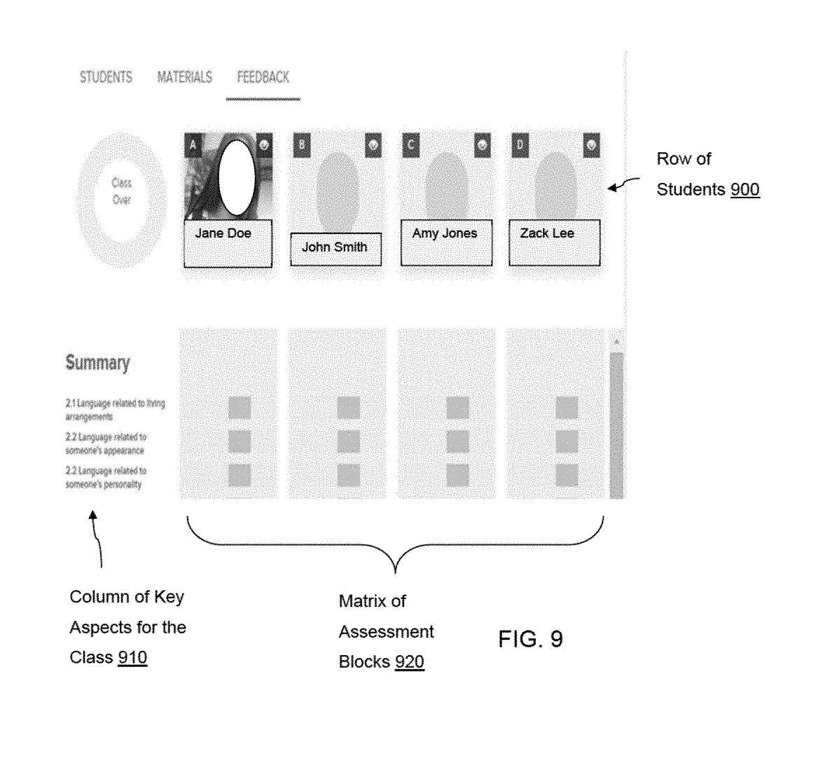

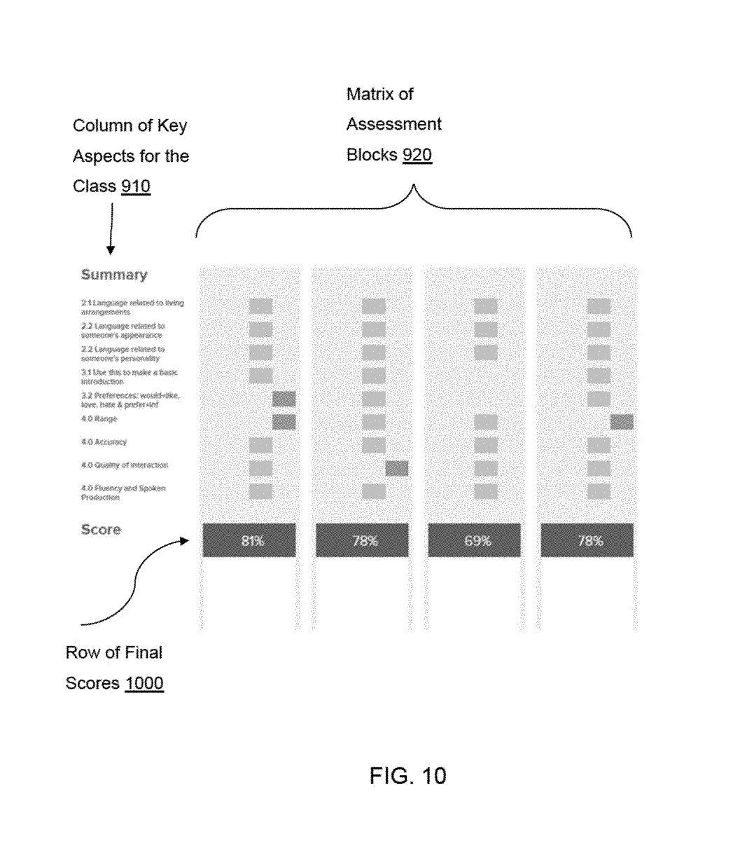

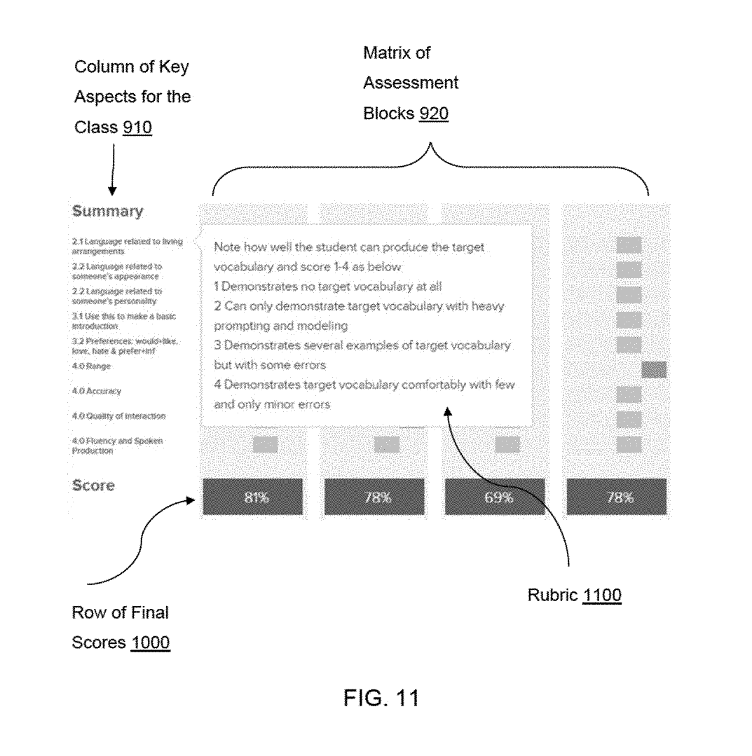

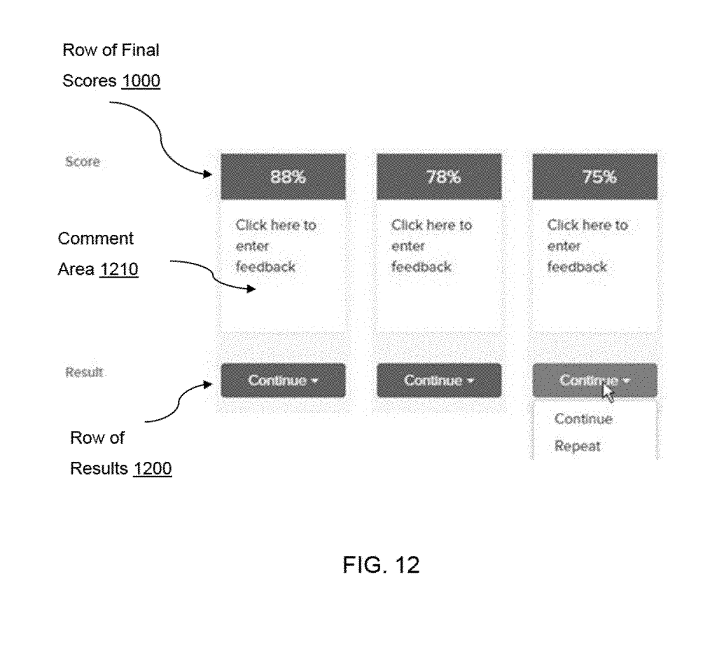

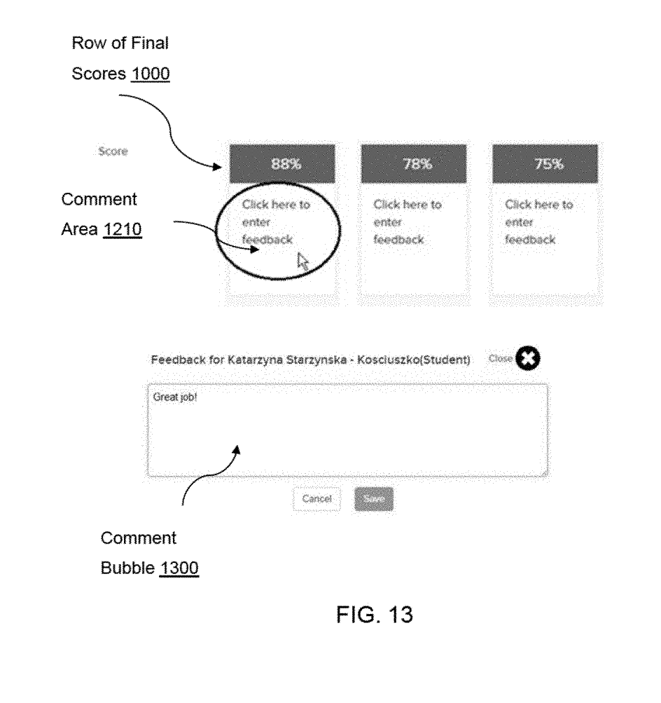

Example screenshots of the interface for the class assessment tool are illustrated in FIGS. 9-15. FIGS. 9, 10 and 12, while blown-up and shown in different figures to enhance their readability, are preferably all visible and displayed on the client device 110 at the same time. In addition, FIG. 11 may be displayed in place of FIG. 10 and FIG. 13 may be displayed in place of FIG. 12.

The teacher may select an upcoming class using any desired method. As a non-limiting example, the teacher may select a class listed in an electronic calendar or in an electronic schedule of classes for the teacher by pressing or hovering over the displayed class with a finger, thumb or stylus. Selecting a specific class on the client device 110 may be used to trigger the client device 110 to start the class assessment tool. Students are preferably preregistered for each class so the client device 110 may read from the database 150 which students are enrolled in the class. The client device 110 may use the information regarding which students are enrolled in the class and information regarding the class to build and display an interface for the class assessment tool that is displayed on the display of the client device 110.

The interface for the class assessment tool may be displayed on the client device 110 and preferably comprises a row of students 900 enrolled in the class which are preferably at or near the top of the display on the client device 110. (Step 200) Each student is preferably represented by a picture and the name of the student. The client device 110 may retrieve each student's picture and name from a database 150 and display the picture and name in the row of students 900.

Alternatively, the teacher may take a picture of one or more of the students with a camera or with a camera on the client device 110 and/or type in one or more of the students' name and display the picture and name in the row of students 900. In some cases, some of the students' pictures and name may be read from the database 150 while the teacher may take the picture and enter the names of other students that are not already represented or stored in the database 150. Each picture and/or name of a student in the interface of the class assessment tool may be used to identify a column of data associated with the student.

In preferred embodiments, the teacher may add new students, delete students, reorder students and/or change which students are visible or active in the row of students 900. The teacher may accomplish these updates by dragging (pressing a finger, thumb or stylus against the display and sliding the finger, thumb or stylus across the display to a new position) pictures and/or names to new locations and/or selecting different icons that allow students to be added or deleted from the row of students 900.

The client device 110 may display a column of a plurality of key aspects 910 of the class below and preferably to the left of the row of the students in the class. Each key aspect may be a specific part or topic covered in the class. Thus, the key aspects 910 are generally different from class to class. The key aspects may be the most important topics taught in the class or the key aspects may be the topics that when evaluated provide the most information in determining the skill level of the students.

As a non-limiting example, a uniform scale may be determined in measuring the abilities of all students within a group of students. As an example where the uniform scale determines a language skill for the English language, the uniform scale may be referred to as a global scale of English. In determining the global scale of English, various topics or key aspects may be assessed in determining each student's language skill. The key aspects may be those topic areas that have been determined to provide the most information regarding a student's skill level. The key aspects that are selected and assessed for a particular class may be a subset of the questions or key aspects used in determining other students' global scale of English. By using key aspects in a class tied to the global scale of English found in a much larger population of students, improved testing areas (key aspects) may be determined and used.

As non-limiting examples of key aspects 910, a key aspect in an English learning class may be: 1) language related to living arrangements, 2) language related to someone's appearance, 3) language related to someone's personality, 4) language related to making a basic introduction and 5) language showing preferences—such as would plus like, love or hate. Any number of key aspects 910 may be used covering any desired topics taught in the class.

The client device 110 may be preprogrammed with the key aspects 910 for each class or the client device 110 may read the key aspects 910 for a class from the server database 150. The key aspects 910 for classes that teach the same subject matter are preferably the same for all teachers that teach the class, no matter the teacher, location or time of the class. As all teachers use the same key aspects 910 to assess all of the students that took the class covering the same subject matter, the students receive a more consistent evaluation regardless of the teacher, location or time of the class. In a preferred embodiment, the key aspects 910 are predefined and preprogrammed “aspects,” common for all teachers, taken from a publicly available syllabus aligned to globally recognized standards, applied to a specific class. Each individual class may correspond to a specific set of key aspects 910 which are assessed for that class.

As another feature, the interface of the assessment tool running on the client device 110 may display a rubric 1100 for scoring one or more (preferably all) of the key aspects 910 of the class. In a preferred embodiment, by placing a cursor or pressing a finger, thumb or stylus over a key aspect displayed on a touch screen, a rubric 1100 specific to that key aspect is displayed on the client device 110. (Steps 210 and 410) The teacher may then assess the student in light of the rubric that is displayed on the client device 110. In other words, the teacher may see the rubric displayed on the client device 110 at the same time the teacher is accessing the student to assist the teacher in using the same objective standards that all the other teachers are using to access students.

Referring to FIG. 11, a non-limiting example of a rubric 1100 is illustrated. In this example, after the teacher hovered over the key aspect of “2.1 language related to living arrangements” for a short period of time (such as a second) a rubric 1100 is displayed on the interface of the client device 110.

The rubric 1100 in this example states “Note how well the student can produce the target vocabulary and score 1-4 as below 1 Demonstrates no target vocabulary at all 2 Can only demonstrate target vocabulary with heavy prompting and modeling 3 Demonstrates several examples of target vocabulary but with some errors 4 Demonstrates target vocabulary comfortably with few and only minor errors.” In the illustrated example in FIG. 11, the rubric 1100 is displayed over a matrix of assessment blocks 920, but the rubric 1100 may also be displayed anywhere on the interface of the assessment tool or on the display of the client device 110.

Each rubric 1100 may be different for each key aspect and is preferably customized for assessing each key aspect in the column of key aspects 910. In an alternative embodiment, the teacher may provide an audio trigger for displaying the rubric 1100 by saying, as non-limiting examples, “display the rubric for item 2.1” or “display the rubric for language related to living arrangements.”

After the teacher has determined a score for a student on a key aspect, possibly using a displayed rubric 1100, the teacher may enter the score in a matrix of assessment blocks 920 displayed on the interface of the assessment tool or display of the client device 110. The matrix of assessment blocks 920 may be displayed anywhere on the interface or the display, such as, as a non-limiting example, below the row of students 900 in the class as illustrated in FIG. 9. The scores may use any desired scale, such as, as non-limiting examples, letter grades, a binary pass or fail, integer numbers between 1 and 10 or integer numbers between 1 and 100. In another embodiment, each assessment block may be a counter button and the teacher may press the counter button a number of times to indicate a keys aspect score for the student. As an example, the teacher may press the counter button each time the student correctly performs a task to indicate a key aspect score for the student for the key aspect being tested.

In a preferred embodiment, the score assigned to each student for each key aspect is either a 1, 2, 3 or 4. This has several advantages. First, four possible scores allows for enough differentiation between the student's ability for the key aspect taught in the class to determine whether or not the student knows the material without making the rubric 1100 overly cumbersome or unnecessarily detailed. And second, each block in the matrix of assessment blocks 920 may be divided into four individually selectable assessment areas that are small enough to all fit on the interface or display, but big enough that a teacher may use a finger, thumb or stylus to select the desired score. (Step 220)

In some embodiments the teacher may press or hover over one of the four individually selectable assessment areas in an assessment block to indicate or select a key aspect score for a particular student for a particular key aspect taught in the class. In a preferred embodiment, the selected assessment area may be highlighted or its color changed so that the teacher may easily see the key aspect score the teacher selected for the student for the key aspect. (Step 420)

As illustrated in FIG. 10, a final score for each student in the class may be displayed on the display of the client device 110 or the interface of the class assessment tool in a row of final scores 1000. (Step 300) The final score for each student is preferably displayed below the picture and name of the student. The final score for each student may be displayed and updated each time a new key aspect score is entered into the matrix of assessment blocks 920 for the student or only after all of the student's scores are entered into the matrix of assessment blocks 920 for the student. Only displaying a final score after all of the key aspect scores have been entered has the advantage of easily letting the teacher know whether all of the key aspect scores have been entered. Specifically, if the final score is not displayed, then not all of the key aspect scores have been entered and the teacher may take appropriate action.

The final score may be calculated, displayed and represented in any desired format. As non-limiting examples, the final score may be a letter grade, a binary score of 0 or 1, a score between 1 and 10 or a score between 1 and 100. In a preferred embodiment, the score is a percentage ranging from 0 to 100 percent based on the scores for each key aspect for the student associated with the final score. (Step 800)

As a non-limiting example, if each key aspect is given a score of 1, 2, 3 or 4, than if a student received all 1's, the student may have a final score of 0%; if the student received all 2's, the student may have a final score of 33%; if the student received all 3's, the student may have a final score of 67%; and if the student received all 4's, the student may have a final score of 100%. While these examples assumed the student received all of the same scores to keep the examples simple, students are likely to receive different scores for different key aspects 910 taught in the class. In these cases the student's scores may be averaged and then converted to a percentage to determine the student's final score.

As illustrated in FIG. 12, a row of comment areas 1210 may be displayed on the interface to the class assessment tool or the display of the client device 110. (Step 310) Each comment area 1210 in the row of comment areas 1210 may be below a student in the class. Selecting a comment area 1210 (by pressing or hovering over the comment area 1210 with a finger, thumb or stylus) may trigger a display of a comment bubble 1300 configured to enable the teacher to enter a comment to the student. In a preferred embodiment, the comment is private and can only be seen by the student when the student is accessing the student's account on the student's client device 120, 130. The comment may be transmitted from the client device 110 of the teacher to a database 150 operated on a server 140. When the student logs into the student's account and is authenticated (possibly using a user name and password) the server 140 may retrieve the comment from the database 150 and transmit the comment to the student's client device 120, 130.

Also as illustrated in FIG. 12, a row of results 1200 may be displayed on the interface for the class assessment tool or on the display of the client device 110. (Steps 320 and 400) Preferably, each student's result is below the picture and name of the student. While the results 1200 may be displayed in any desired scale, in preferred embodiments, the scale for the result is binary and the student either failed the class (and should retake the class) or the student passed the class (and should continue to the next class). (Step 810)

Each result may be automatically determined and displayed on the display of the client device 110 based on the final score of the student. As a specific non-limiting example, if the student received a final score of 69% or less, the student may automatically be given a fail, while all other students having a final score greater than 69% may be given a pass. In some embodiments, the teacher may be provided an override capability to replace a fail or a pass that was automatically selected by the client device 110 with a different result the teacher believes is more appropriate.

Alternatively, as illustrated in FIG. 12, the teacher may select (by pressing or hovering over an icon with a finger, thumb or stylus) an icon in the row of results 1200 which then displays a drop-down menu from which the teacher may select a result. This allows the teacher some flexibility in determining whether a student should proceed to the next class or retake the current class. This may be advantageous based on feedback from the student and/or intuition of the teacher as to what is best for the student based on the teacher's past experiences.

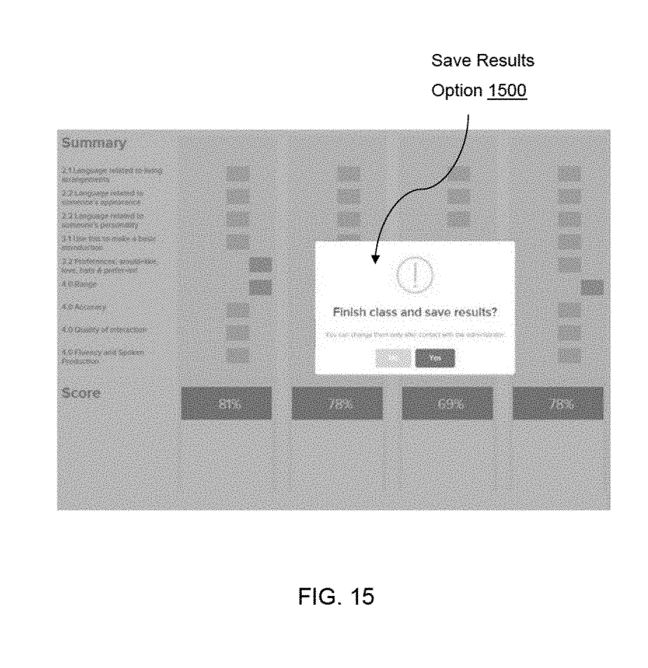

Referring to FIG. 15, after the teacher has finished assessing the students in the class on the key aspects 910, the teacher may be given a save results option 1500 to finish the class and save the results. If the teacher selects to finish the class and save the results, the client device 110 may transmit the key aspect scores, final score and/or result (now historical test results) for the one or more students in the class over the Internet 100 to a server running a database 150. The database 150 may store the historical test results for future analysis or access of the scores by an administrator, teacher or the student that received the scores. (Step 820)

In some embodiments, the key aspect scores, final scores and results for a plurality of different students, at a plurality of different geographical locations (possibly world-wide) with a plurality of different teachers may be stored in the database 150 and analyzed by one or more servers 140. The analysis may include data from a plurality of different classes, where each class is preferably standardized as to the content taught and the objective grading system used for the class. This standardization of each class (subject matter taught and objective grading system), allows the server(s) 140 to compare the pass (continue) and failure (repeat) rates across different locations, across different teachers, and/or across different sets of students. The information gained from the different comparisons may be used to draw insights on the performance of the different locations and teachers and to make improvements as needed.

The database 150 is preferably accessible to a plurality of client devices 110, 120, 130, once the client devices 110, 120, 130 have been authenticated, such as a user of the client device 110, 120, 130 entering a correct account name and associated password. In addition, the database 150 preferably only allows an authenticated client device 110, 120, 130 to access data that is appropriate for the user of the client device 110, 120, 130. Thus, each student is preferably only given access to that student's information, while a teacher may be given access to the information for all of the students of the teacher. An administrator of the database 150 may have access to all of the information in the database 150.

Preferably, all ratings, final scores, overall results and comments for all of the students are stored in a database 150 operated on a server 140. Each student may have an account that may display, as an example, a personal gradebook on a client device 120, 130 of the student. Once the student is authenticated, possibly by using a username and password or any other desired method, the student may be given access to the student's ratings, final scores, overall results and comments in the student's personal gradebook.

While certain example screens have been illustrated in FIGS. 9-15, other screens may also be displayed to the teacher to help the teacher keep track of classes, students and scores. As examples, a screen illustrating a calendar may be displayed to help a teacher keep track of the teacher's classes and to allow the teacher to select classes so that the teacher may review the students enrolled in the class. In addition, screens may be added that display student information so that the teacher may be prepared and able to customize the class based on the individual needs of the students enrolled in the class.

Unless specifically stated otherwise, all rows are defined to be displayed horizontally and all columns are defined to be displayed vertically on the interface of the class assessment tool and the display of the client device 110.

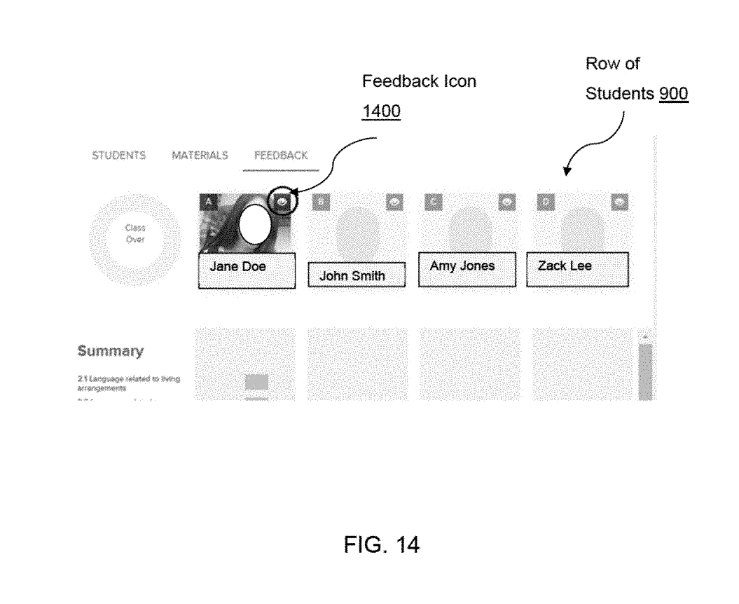

Referring to FIG. 14, a feedback icon 1400 associated with a student may be selected by the teacher that enables the client device 110 being used by the teacher to enter a privacy mode. When the client device 110 is in privacy mode, the client device 110 only displays the information for the student associated with the selected feedback icon 1400. The information for all of the other students is not displayed on the display of the client device 110 so that the teacher may show the client device 110 to the selected student without revealing the private information (grades, etc.) of the other students.

In some embodiments, the client device 110 may have the capability to take one or more pictures, one or more video clips and/or one or more audio recordings of the student (and possibly the teacher and/or other students) during the class. (Steps 500 and 600) In these embodiments, the client device 110 may comprise a camera, video recorder, audio recorder and/or speakers to take the pictures, videos and audio recordings and to hear the audio recordings. The pictures, video clips and/or audio recordings, possibly with an added text message or audio recording from the teacher, may be communicated to a different client device 120, 130 operated by the student as feedback from the teacher. The picture(s), video clip(s), and/or audio recordings combined with text or an audio recording from the teacher may be valuable feedback to the student and assist the student in improving the student's ability. (Steps 510 and 610)

As a specific example, the teacher may take an audio recording of the way a student pronounces a word or phrase using the client device 110 and the teacher may provide an additional audio recording of the teacher saying the word or phrase correctly. The audio recording may initially be stored on internal memory of the client device 110 of the teacher. The audio recording may be transmitted from the client device 110 used by the teacher to a database 150 operated on a server 140. The student may access the student's account by entering a username and password assigned or created by the student. Once the student has been authenticated, the server may read the audio recording from the database 150 and transmit the audio recording to a client device 120, 130 used by the student. The client device 120, 130 operated by the student preferably has a speaker that enables the client device 120, 130 to play the audio clip. In another embodiment, the client device 110 of the teacher may transmit the audio clip directly to the client device 120, 130 used by the student using any desired communication protocol, such as Bluetooth. This allows the student to have immediate access to the audio clip thereby enhancing the learning experience of the student.

The student, after hearing the audio clip played on the speakers of the client device 120, 130 used by the student and the way the student says the word or phrase and the way the teacher says the word or phrase, may be able to practice saying the word or phrase correctly as the teacher says the word or phrase, thereby improving the language skill of the student.

In another embodiment, the feedback icon 1400 illustrated in FIG. 14 may be selected by the teacher using the touch screen of the client device 110 and a list of prepopulated feedback may be displayed on the display of the client device 110 for the teacher to select as appropriate for the student. The prepopulated feedback may be stored on a database 150 running on one or more servers 140. Each class may be mapped on the database 150 to a plurality of prepopulated feedback that is appropriate for the class. The client device 110 may transmit the class to the server 140 and the server 140 may read from the database 150 the prepopulated feedback that is most likely to be used for that class. The server 140 may then transmit the prepopulated feedback appropriate for the class to the client device 110 of the teacher. In another embodiment, the class assessment tool running on the client device 110 may already be preprogrammed with all of the prepopulated feedback. This embodiment allows the client device 110 to read its own internal storage (such as a hard disk drive or a solid state device) to determine the appropriate prepopulated feedback for each class the teacher teaches. This improves on the speed and efficiency of the teacher in providing feedback to the student.

As an example, the prepopulated feedback may be “Great Job,” “You are improving, keep up the good work” or “Please see me after class so we can discuss strategies to improve your progress.” Having prepopulated feedback allows the teacher to quickly and easily select and send an appropriate message to the student. In some embodiments, the prepopulated feedback may be customized based on the topics taught in the class and refer to areas or key aspects that commonly need additional help. (Steps 700, 710)

Each final score in the row of final scores 1000 may be determined using any desired method. As a non-limiting example, each final score may be calculated using a probability model or by weighting the scores for each key aspect differently.

As an example, a probability of a student's future success in the next class may be determined based on the success or failure of past students that received the same or similar key aspect scores as the student. The probability model may be, as a non-limiting example, a Bayesian network, where the key aspect scores are weighted. Specifically, the key aspect scores that are better at assessing a student are given a greater weight than key aspect scores that are not as good at assessing the student. The weight for each key aspect score may be stored in a database 150 operated on a server 140 and transmitted to the client device 110 during or immediately after the class or the client device 110 may be preprogrammed with the weight for each key aspect score stored in a memory of the client device 110 operated by the teacher. By comparing the current student to past students, a probability of the student succeeding at the next level may be determined based on the past key aspect scores of the other students compared to the key aspect scores of the student. Students that have a high probability of success based on their key aspects scores may be passed to the next class, while students that have a low probability of success based on their key aspect scores may be requested to repeat the class.

As another example, it may be determined that one or more key aspects are not as good as other key aspects in determining whether a student should proceed to the next class. These less reliable key aspects may be given a lower weight in determining each student's final score. On the other hand, key aspects that have a very high correlation between scores and predicting the future success of a student may be given a higher weight in determining each student's final score. By decreasing or increasing the weight given to the various key aspect scores, an improved and more reliable final score for each student may be calculated. Students with a high final score using weighted key aspects may continue to the next class, while students with a low final score using weighted key aspects may be required to repeat the class.

Another possible feature of the invention is improving the assignment of homework based on the key aspect scores of the student. Teachers typically assign all students the same homework. However, this method does not account for the fact that different students have different strengths and weaknesses. It is not an effective use of a student's time to practice areas that the student already knows, while not practicing areas that the student is struggling with. To remedy this problem, the client device 110 may customize the homework assigned to each student based on the key aspect scores of the student. Specifically, the homework assignments may be specifically designed to improve a particular key aspect for a student.

In some embodiments, a database 150 operated on a server 140 may store each key aspect and one or more homework assignments that are linked or associated with the key aspect. In other embodiments, an internal memory (such as a hard disk drive or a solid state device) of the client device 110 may store each key aspect and one or more homework assignments that are linked or associated with the key aspect. In either system the key aspect may be used as a key in locating the linked homework assignments to be assigned to the student. The key aspect may also be mapped to one or more homework assignments.

The client device 110 may determine a student needs homework by comparing each key aspect score to a predetermined threshold for the key aspect used to determine whether or not to assign homework to a student. As a specific example, if the key aspect score may be a 1, 2, 3 or 4, homework may be assigned for that key aspect if the student received a key aspect score of a 1 or a 2.

As another example, if a first student received a low key aspect score for the key aspect of language related to living arrangements, but high key aspect scores for the other key aspects in the class, the first student may receive a homework assignment only related to improving the student's language relating to living arrangements. In the same class if a second student received a low key aspect score for the key aspect of language related to someone's appearance, but high key aspect scores for the other key aspects in the class, the second student may receive a homework assignment only related to improving the student's language related to someone's appearance.

The homework may be individually assigned to each student automatically by the client device running the class assessment tool based on each student's key aspect scores. In another embodiment, the teacher may review the key aspect scores for each student on the client device and the teacher may customize and assign the homework to each student based on the student's key aspect scores.

A client device 120, 130 of the student may receive the assigned homework either from a database 150 operated by a server 140 when the student logs in to the student's account or the client device 120, 130 of the student may receive the assigned homework directly from the client device 110 of the teacher.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A method for a class assessment tool on a wireless first client device comprising a touch screen display operated by a teacher to assess one or more students in a class, comprising the steps of:
displaying a class assessment interface on the first client device, wherein the class assessment interface comprises a row of students, a column of key aspects for the class, a matrix of assessment blocks, wherein each assessment block comprising a plurality of individually selectable assessment areas, a row of final scores and a row of results;
upon detecting a hovering over any of the key aspects in the column of key aspects for the class, displaying a rubric that describes scoring the hovered over key aspect;
upon detecting a selection of any of the plurality of individually selectable assessment areas for a key aspect for a student, entering a key aspect score associated with the selected assessment area for the key aspect for the student;
taking a picture or a video clip of a first student in the class from the first client device;
communicating the picture or the video clip to a second client device operated by the first student as feedback from the teacher;
calculating a final score in the row of final scores based upon the entered key aspect scores for each student;
calculating a result in the row of results based upon the final score for each student; and
upon receiving a save option selection from the teacher, storing the key aspect scores for each student in the class in a database accessible by other client devices connected to the Internet.

2. The method of claim 1, wherein the client device comprises a handheld wireless device.

3. The method of claim 1, further comprising the step of:
transmitting by the client device a plurality of historical test results for the one or more students in the class to the database.

4. The method of claim 1, further comprising the steps of:
receiving and storing by the database each final score in the row of final scores and each result in the row of results; and
associating each final score and each result with one of the students in the class.

5. The method of claim 1, wherein each assessment block comprises four individually selectable assessment areas for scoring a student in the class on a key aspect in the plurality of key aspects.

6. The method of claim 1, wherein each final score in the row of final scores is a percentage based on the scores of the student.

7. The method of claim 1, wherein each result in the row of results represents a binary result indicating either the student should repeat the class or the student should proceed to a next higher class.

8. A method for a class assessment tool on a wireless first client device comprising a touch screen display operated by a teacher to assess one or more students in a class, comprising the steps of:
displaying a class assessment interface on the first client device, wherein the class assessment interface comprises a row of students, a column of key aspects for the class, a matrix of assessment blocks, wherein each assessment block comprising a plurality of individually selectable assessment areas, a row of final scores and a row of results;
upon detecting a hovering over any of the key aspects in the column of key aspects for the class, displaying a rubric that describes scoring the hovered over key aspect;
upon detecting a selection of any of the plurality of individually selectable assessment areas for a key aspect for a student, entering a key aspect score associated with the selected assessment area for the key aspect for the student;
recording an audio clip of a first student in the class from the first client device;
communicating the audio clip to a second client device operated by the first student as feedback from the teacher;
calculating a final score in the row of final scores based upon the entered key aspect scores for each student;
calculating a result in the row of results based upon the final score for each student; and
upon receiving a save option selection from the teacher, storing the key aspect scores for each student in the class in a database accessible by other client devices connected to the Internet.

9. The method of claim 8, further comprising the step of:
transmitting by the client device a plurality of historical test results for the one or more students in the class to the database.

10. The method of claim 8, further comprising the steps of:
receiving and storing by the database each final score in the row of final scores and each result in the row of results; and
associating each final score and each result with one of the students in the class.

11. The method of claim 8, wherein each assessment block comprises four individually selectable assessment areas for scoring a student in the class on a key aspect in the plurality of key aspects.

12. The method of claim 8, wherein each final score in the row of final scores is a percentage based on the scores of the student.

13. The method of claim 8, wherein each result in the row of results represents a binary result indicating either the student should repeat the class or the student should proceed to a next higher class.

14. A method for a class assessment tool on a wireless first client device comprising a touch screen display operated by a teacher to assess one or more students in a class, comprising the steps of:
displaying a class assessment interface on the first client device, wherein the class assessment interface comprises a row of students, a column of key aspects for the class, a matrix of assessment blocks, wherein each assessment block comprising a plurality of individually selectable assessment areas, a row of final scores and a row of results;
upon detecting a hovering over any of the key aspects in the column of key aspects for the class, displaying a rubric that describes scoring the hovered over key aspect;
upon detecting a selection of any of the plurality of individually selectable assessment areas for a key aspect for a student, entering a key aspect score associated with the selected assessment area for the key aspect for the student;
selecting a feedback from a pre-populated list of feedback for a first student in the class from the first client device;
communicating the selected feedback to a second client device operated by the first student as feedback from the teacher;
calculating a final score in the row of final scores based upon the entered key aspect scores for each student;
calculating a result in the row of results based upon the final score for each student; and
upon receiving a save option selection from the teacher, storing the key aspect scores for each student in the class in a database accessible by other client devices connected to the Internet.

15. The method of claim 14, wherein the client device comprises a handheld wireless device.

16. The method of claim 14, further comprising the step of:
transmitting by the client device a plurality of historical test results for the one or more students in the class to the database.

17. The method of claim 14, further comprising the steps of:
receiving and storing by the database each final score in the row of final scores and each result in the row of results; and
associating each final score and each result with one of the students in the class.

18. The method of claim 14, wherein each assessment block comprises four individually selectable assessment areas for scoring a student in the class on a key aspect in the plurality of key aspects.

19. The method of claim 14, wherein each final score in the row of final scores is a percentage based on the scores of the student.

20. The method of claim 14, wherein each result in the row of results represents a binary result indicating either the student should repeat the class or the student should proceed to a next higher class.
